(19) United States
(12) Patent Application Publication
(10) Pub. No.: US 2026/0347011 A1
(43) Pub. Date: Nov. 5, 2026

(54) METHOD FOR REFLECTING SUNLIGHT FROM SATELLITES TO OIL AND GAS LOCATIONS

(71) Applicant: Tenax Energy Systems, LLC, Clinton, OK (US)

(72) Inventor: Kevin Dewayne Jones, Clinton, OK (US)

(21) Appl. No.: 19/666,912

(22) Filed: May 4, 2026

Related U.S. Application Data
(60) Provisional application No. 63/799,516, filed on May 3, 2025.

(51) Int. Cl. B64G 1/24; F21S 11/00; G02B 26/08

(52) U.S. Cl. CPC B64G 1/244; F21S 11/00; G02B 26/0816

(57) ABSTRACT

A method is disclosed for providing illumination to a terrestrial target location using reflected sunlight. The method includes receiving a user request identifying a target location and illumination time, identifying one or more satellites positioned to receive sunlight, calculating reflection parameters, and transmitting control signals to orient reflective elements carried by the satellites. Sunlight is reflected toward the target location during selected orbital windows to provide supplemental illumination. In some embodiments, multiple satellites are coordinated to extend illumination duration, and operational data or sensor feedback is used to assess or adjust illumination events.

### FIELD OF THE INVENTION

The present invention relates to methods for satellite-based solar reflection, and more particularly to a method for directing sunlight from orbiting satellites to oil and gas facilities to provide illumination during low-light or nighttime conditions, thereby enhancing operational safety, efficiency, and energy utilization.

### BACKGROUND OF THE INVENTION

Oil and gas operations, such as drilling, refining, and pipeline maintenance, often occur in remote or harsh environments where natural daylight is limited, particularly at night or in high-latitude regions with extended darkness. Conventional lighting solutions, such as high-intensity discharge lamps powered by fossil fuel generators, are energy-intensive, costly, and contribute to carbon emissions. Satellite-based sunlight reflection, as demonstrated by prior art like the Russian Znamya project of the 1990s, has shown the potential to illuminate terrestrial targets using orbiting mirrors. Recent proposals, such as Reflect Orbital’s satellite constellation for solar farm illumination, leverage advancements in lightweight reflective materials and orbital mechanics but are not optimized for the specific needs of oil and gas facilities, such as high-intensity, localized illumination over rugged or offshore sites.

There is a need for a method that systematically directs reflected sunlight from satellites to oil and gas locations, enabling on-demand illumination, reducing energy costs, and supporting energy-intensive processes like thermal enhanced oil recovery (EOR). The present invention addresses this need by providing a novel method for scheduling, targeting, and delivering reflected sunlight to oil and gas sites with high precision and efficiency.

While the prior art methods mentioned above do provide for the provision of sunlight, they are typically done in areas where significant infrastructure exists for, for example, power production. There is a need to provide emergency lighting to extremely remote regions where it may be difficult or impossible to provide power infrastructure and portable lighting.

### SUMMARY OF THE INVENTION

The invention provides a method for reflecting sunlight from satellites to oil and gas locations, enabling targeted illumination during low-light or nighttime conditions. The method involves receiving user requests for illumination, identifying suitable satellites in a constellation, calculating optimal orbital and reflection parameters, directing sunlight to the target location, and coordinating multiple satellite passes to extend illumination duration. The method is designed to support oil and gas operations, including drilling, maintenance, safety monitoring, and energy generation, while minimizing reliance on traditional lighting systems.

In one embodiment, the method utilizes a constellation of low Earth orbit (LEO) satellites, each equipped with steerable reflective panels (e.g., mylar mirrors), to reflect sunlight into a concentrated beam with a ground footprint of 1-3 kilometers in diameter. A ground-based control system processes user inputs, such as GPS coordinates and desired illumination times, to compute mirror angles and satellite trajectories. The method ensures illumination intensities of approximately 50-100 W/m², suitable for operational visibility or supplemental energy generation at oil and gas sites.

### BRIEF DESCRIPTION OF THE DRAWINGS

FIG. 1 is a schematic diagram illustrating the operational environment of the method, including satellites, a ground control station, and an oil and gas target location.

FIG. 2 is a flowchart depicting the steps of the method for reflecting sunlight to an oil and gas location.

### DETAILED DESCRIPTION OF THE INVENTION

The method of the present invention enables the precise delivery of reflected sunlight from a constellation of satellites to oil and gas locations, such as offshore drilling platforms, onshore refineries, or pipeline monitoring stations. The method leverages a satellite constellation in low Earth orbit (LEO), typically at 500-600 kilometers altitude in a sun-synchronous polar orbit, to ensure continuous sunlight exposure. Each satellite is equipped with a deployable reflective panel, such as a 10-meter by 10-meter mylar mirror, capable of redirecting sunlight into a concentrated beam. A ground control station and user interface facilitate the scheduling and execution of illumination events.

In particular, the invention allows for the provision of light and power to remote locations that, irrespective of the time of day, would otherwise not, or where power would require the use of either generators (which require transportation of fuel) or transmission lines (which are subject to loss, expensive, and unfeasible in some locations).

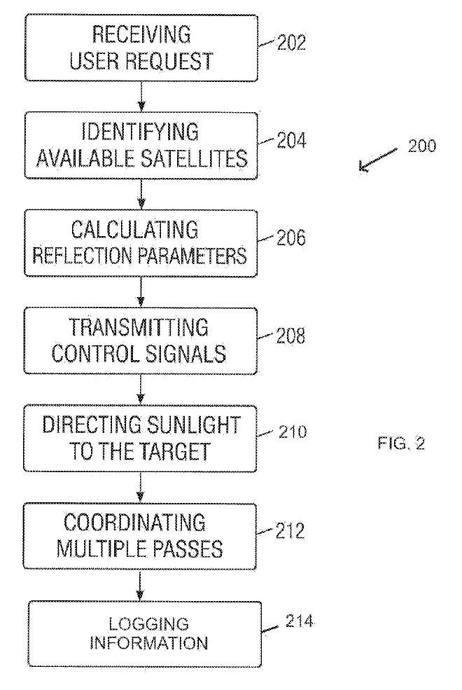

Referring to FIG. 2, the method 200 for reflecting sunlight to oil and gas locations comprises the following steps:

### Step 202: Receiving a User Request

A user, such as an oil and gas facility operator, submits a request for illumination via a web-based or mobile application interface. The request specifies the GPS coordinates of the target oil and gas location (e.g., latitude and longitude of an offshore platform), the desired illumination time (e.g., 20:00 UTC on a specific date), and the required duration (e.g., 30 minutes) and intensity (e.g., for visibility or energy generation). Optional parameters, such as integration with on-site solar panels for energy capture may also be used. The request is transmitted to a ground control station equipped with computational resources for processing.

The user request may include the workplace activities taking place at a job site – for example, certain job functions require certain light levels to meet operational safety standards, such as OSHA standards. The user request may indicate what activities are taking place and modulate the light levels to meet the minimum required light levels.

It should be understood that the light levels required to safely work at a job site may be lower than that required to, for example,operate solar power generation. Therefore, the efficiency of operating at lower levels allows remote areas to have appropriate light levels at night without portable light, without providing more light than necessary, which may cause regulatory or efficiency issues.

### Step 204: Identifying Available Satellites

The ground control station queries a database of the satellite constellation’s orbital parameters to identify satellites capable of illuminating the target location at the requested time. This involves determining which satellites will be in a suitable orbital position to receive sunlight and reflect it to the target. The control system must also verify that the satellites have sufficient power and operational reflective panels, and then one or more satellites are selected based on their proximity to the target’s zenith and availability of reflection windows (typically 5-15 minutes per pass).

### Step 206: Calculating Reflection Parameters

Using orbital mechanics software, the ground control station calculates the optimal parameters for reflecting sunlight, including the precise angle of the satellite’s reflective panel to direct sunlight to the target GPS coordinates, the satellite’s position relative to the sun and the target, accounting for the Earth’s curvature and atmospheric effects, and the expected ground footprint (e.g., 1-3 km diameter) and illumination intensity (e.g., 50-100 W/m²).

Calculations incorporate real-time data, such as satellite telemetry, solar position, and atmospheric conditions (e.g., cloud cover), to improve accuracy.

### Step 208: Transmitting Control Signals

The ground control station sends radio frequency commands to the selected satellite(s) to adjust the attitude of the satellite using reaction wheels or thrusters for coarse alignment. The reflective panel’s orientation is fine-tuned (e.g., ±0.1-degree precision) using a gimbal mechanism. The reflection system is activated by deploying or confirming the readiness of the mylar mirror.

### Step 210: Directing Sunlight to the Target

The satellite reflects sunlight to the oil and gas location, producing a concentrated beam that illuminates the target area. The reflection event is monitored in real-time. Onboard satellite sensors confirm mirror alignment and beam direction. Ground-based sensors at the oil and gas site (e.g., lux meters) measure illumination intensity and provide feedback to the ground control station. The illumination supports activities such as equipment maintenance, safety inspections, or thermal processes.

Feedback provided to the satellite array from the control system helps the system to account for changes to atmospheric conditions, operational needs, etc. For example, if light gets too high, as determined by the ground sensors, a signal may be made to direct less sunlight to the target.

In addition, frequencies of visible light may be changed to both increase the impact of the light at the target, and decrease the light transmitted at the edges of the illuminated zone, so as not to impact people or natural processes in an area larger than necessary.

### Step 212: Coordinating Multiple Passes

To extend the illumination duration beyond a single satellite pass (5-15 minutes), the method coordinates sequential passes of multiple satellites. This involves scheduling additional satellites to reflect sunlight during subsequent orbital windows. Reflection parameters may be adjusted for each pass to maintain consistent illumination, and coordinated for any gaps between satellites.

### Step 214: Logging and Reporting

After the illumination event, the ground control station logs operational data, including satellite performance metrics (e.g., mirror alignment accuracy, power consumption), illumination outcomes (e.g., measured intensity, duration, user feedback), etc. A report is generated and sent to the user via the interface, confirming the completion of the request and providing performance details.

### Operational Environment

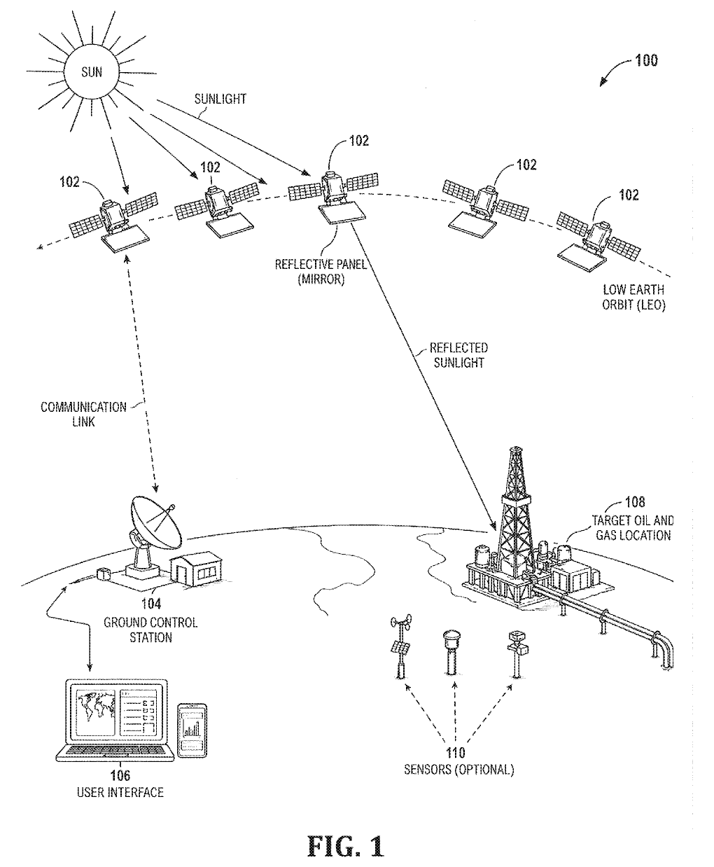

As shown in FIG. 1, the method operates within a system 100. The system 100 includes a constellation of LEO satellites 102, each with a steerable mylar mirror (10m x 10m, >90% reflectivity). A ground control station 104 with computational and communication capabilities is controlled at a user interface 106 for submitting and managing illumination requests. The user interface 106 need not be at the same location as a target oil and gas location 108. The target oil and gas location 108 may be equipped with optional sensors 110 for real-time feedback.

As shown in FIG. 1, the method 200 operates within a system 100. The system 100 includes a constellation of satellites 102, which in one embodiment comprise low Earth orbit (LEO) satellites. Each satellite is equipped with a steerable reflective element configured to redirect incident sunlight toward a terrestrial target location. In one example embodiment, the reflective element comprises a deployable mylar mirror having dimensions on the order of approximately 10 meters by 10 meters, and a reflectivity greater than approximately 90 percent. The reflective element may be supported by a frame, boom, or tensioned structure and may be configured to be deployed after launch. It should be understood, however, that other reflective element sizes, materials, surface finishes, curvatures, or segmented configurations may be used depending on orbital altitude, desired illumination footprint, structural constraints, launch vehicle limitations, or mission objectives.

While LEO satellites are discussed herein for purposes of illustration due to their relatively low latency, reduced signal delay, and proximity to the Earth’s surface, other orbital regimes may be utilized without departing from the spirit of the invention. For example, satellites in medium Earth orbit (MEO), highly elliptical orbits, or other non-geostationary orbits may be employed to achieve different coverage patterns, illumination durations, or revisit rates. Selection of orbital parameters may be based on factors including illumination geometry, duration of sunlight exposure, target latitude, and acceptable temporal gaps between illumination opportunities.

The system 100 further includes a ground control station 104 having computational, data storage, and communication capabilities, the ground control station 104 being operatively coupled to a user interface 106. The user interface 106 enables submission, scheduling, and management of illumination requests, including specification of a target location, desired illumination timing, duration, and other optional operational parameters. The user interface 106 need not be co‑located with the terrestrial target location and may be operated remotely via a networked computing device. In some embodiments, the user interface 106 is configured to receive multiple requests from different users or locations and to prioritize, queue, or resolve conflicts among illumination requests based on predefined rules or system availability.

The ground control station 104 is configured to communicate with the constellation of satellites 102 to transmit control signals that adjust satellite attitude and reflective element orientation, and to receive telemetry, health status, and positional information from the satellites. In some embodiments, the ground control station 104 accounts for orbital dynamics, solar position relative to the Earth and the target location 108, predicted atmospheric conditions, satellite power availability, and reflective element status when determining which satellites are suitable for a given illumination request. The ground control station 104 may compute predicted illumination footprints, expected illumination duration, and timing windows based on orbital motion and may update control commands during an illumination event to compensate for changes in satellite position or environmental conditions.

The terrestrial target location 108, which in one embodiment comprises an oil and gas location, may optionally be equipped with one or more sensors 110. The sensors 110 may include illumination sensors, environmental sensors, imaging devices, or other monitoring equipment configured to provide real-time or near-real-time data indicative of conditions at the target location 108. Sensor data may be communicated to the ground control station 104 and used to assess whether an illumination event occurred as planned, to confirm relative changes in light level, or to inform subsequent operational decisions. In other embodiments, the system operates without ground-based sensors, relying instead on precomputed reflection parameters, satellite telemetry, predictive weather analysis, historical performance data, or post-event evaluation to assess system operation.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A method for providing illumination to a terrestrial target location using reflected sunlight, the method comprising:
receiving, by a ground‑based control system, a user request specifying at least a geographic location of the terrestrial target location and a desired illumination time;
identifying, by the ground‑based control system, one or more satellites in orbit that are positioned to receive sunlight and reflect the sunlight toward the terrestrial target location during the desired illumination time;
calculating, by the ground‑based control system, one or more reflection parameters for each of the one or more satellites;
transmitting control signals from the ground‑based control system to the one or more satellites to cause adjustment of a reflective element of each satellite in accordance with the calculated one or more reflection parameters;
directing, by the one or more satellites, reflected sunlight toward the terrestrial target location to illuminate at least a portion of the terrestrial target location during the desired illumination time.

2. The method of claim 1, further comprising coordinating reflection of sunlight by multiple satellites during sequential orbital passes to extend a duration of illumination at the terrestrial target location.

3. The method of claim 1, further comprising logging operational data associated with the reflected sunlight, including at least one of satellite performance data, illumination intensity data, or illumination duration data.

4. The method of claim 1, wherein the terrestrial target location comprises an oil and gas location.

5. The method of claim 1, in which the reflective element comprises a mirror.

6. The method of claim 1, in which one of the one or more satellites is in low Earth orbit.

7. The method of claim 1, in which the terrestrial target location comprises a disaster relief location.

8. The method of claim 1, in which the reflection parameters include at least an orientation of the reflective element carried by each satellite that directs reflected sunlight toward the terrestrial target location.

9. The method of claim 8, further comprising coordinating reflection of sunlight by multiple satellites during sequential orbital passes to extend the duration of illumination at the terrestrial target location.

10. The method of claim 8, wherein the terrestrial target location comprises an oil and gas location.

11. The method of claim 1, in which the terrestrial target location is at a nighttime location during the desired illumination time.

12. The method of claim 1, further comprising, after the step of directing sunlight to the terrestrial target location:
sensing, at the terrestrial target location, a light level and;
directing the one or more satellites to increase or decrease the light level based upon the sensed light level.
